(19) United States
(12) Patent Application Publication
(10) Pub. No.: US 2022/0126240 A1
(43) Pub. Date: Apr. 28, 2022

(54) HIGH RECOVERY RATE-REVERSE OSMOSIS SPACER AND ELEMENT

(71) Applicant: LG CHEM, LTD., Seoul (KR)

(72) Inventors: Taeyoung PARK, Daejeon (KR); Phill LEE, Daejeon (KR); Taehyeong KIM, Daejeon (KR); Hyelim KANG, Daejeon (KR); Huizi SHEN, Daejeon (KR); Gahyeon LEE, Daejeon (KR); Kiho KIM, Daejeon (KR)

(21) Appl. No.: 17/436,196

(22) PCT Filed: Mar. 19, 2020
(86) PCT No.: PCT/KR2020/003752

§ 371 Date: Sep. 3, 2021

(30) Foreign Application Priority Data
Mar. 22, 2019 (KR) 10-2019-0032841

(51) Int. Cl. B01D 63/10; C02F 1/44; B01D 61/02; B01D 61/08

(52) U.S. Cl. CPC B01D 63/103; C02F 1/441; C02F 2103/08; B01D 61/08; B01D 61/025

(57) ABSTRACT

Provided is a reverse osmosis spacer and a reverse osmosis element with a high recovery rate, and, more particularly, to a reverse osmosis spacer and a reverse osmosis element with a high recovery rate, which are capable of increasing a flow rate of produced water and decreasing less a salt removal rate in the reverse osmosis element during an operation at a high recovery rate with a structure of the reverse osmosis spacer that comprises the reverse osmosis element.

### CROSS-REFERENCE TO RELATED APPLICATION(S)

This application is a National Stage Application of International Application No. PCT/KR2020/003752 filed on Mar. 19, 2020, which claims priority to and the benefit of Korean Patent Application No. 10-2019-0032841 filed with the Korean Intellectual Property Office on Mar. 22, 2019, the entire contents of which are incorporated herein by reference.

### TECHNICAL FIELD

The present invention relates to a reverse osmosis spacer and a reverse osmosis element with a high recovery rate, and more particularly, to a reverse osmosis spacer and a reverse osmosis element with a high recovery rate, which are capable of increasing a flow rate of produced water and decreasing less a salt removal rate in the reverse osmosis element during an operation at a high recovery rate with a structure of the reverse osmosis spacer that constitutes the reverse osmosis element.

### BACKGROUND

Earth is a planet where water occupies 70% of the surface thereof. Seawater accounts for 97.5% of the total amount of water, and the seawater cannot be used as drinking water. Accordingly, a seawater desalination technology has been developed which removes salt dissolved in seawater and converts seawater into fresh water that can be used as drinking water. In the past, a method of producing pure water by boiling seawater and collecting moisture vapor was used. However, recently, a method for producing pure water using a reverse osmosis filter has been used as a core technique for seawater desalination.

Unlike osmosis in which water moves from a site with a low concentration to a site with a high concentration, the reverse osmosis is a phenomenon in which pressure is applied to a high-concentration solution to move water to a low-concentration solution. While coarse salt or contaminants cannot pass through the filter, only water passes through the filter, such that pure and clean water can be obtained. The reverse osmosis is used in various fields for producing sterile water for medical use, purified water, and water for semiconductor manufacturing.

A reverse osmosis element including such a reverse osmosis has been used. The reverse osmosis element is configured by stacking a plurality of reverse osmosis membranes, a plurality of feed spacers, and a plurality of transmissive spacers. The reverse osmosis element surrounds a water collecting pipe. When raw water is supplied to one side of the reverse osmosis element, fine contaminants less than nanometers are filtered out by the reverse osmosis membrane while the raw water flows along the feed spacers, and permeable water is taken out from the other side of the reverse osmosis element. The permeable water filtered by the reverse osmosis membrane flows along the transmissive spacers, flows into holes in the water collecting pipe, and then flows into the water collecting pipe. Therefore, in order to reduce a pressure loss when the raw water flows, the reverse osmosis element has a structure capable of withstanding high pressure. In general, a mesh-shaped spacer is used as the feed spacer, whereby a flow path of the raw water is ensured, a flow of raw water increases, and ion polarization occurring at an interface of the reverse osmosis membrane is mitigated.

Unlike the reverse osmosis elements for industrial (BW) and seawater desalination (SW), the reverse osmosis element for home use in the related art operates at a raw water concentration of 20 ppm, an operating pressure of 50 to 60 psi, and a recovery rate of 15% and has a low flow rate of produced water. However, if the reverse osmosis element operates at a high recovery rate of 60 to 80% in order to increase a flow rate of produced water, there is a problem in that a salt removal rate is decreased by about 5% in comparison with when the reverse osmosis element operates at a low recovery rate.

### BRIEF DESCRIPTION

### Technical Problem

The present invention has been made in an effort to solve the above-mentioned problem, and an object of the present invention is to provide a reverse osmosis element with a high recovery rate, which is capable of reducing ion polarization in the reverse osmosis element by creating an effective flow of raw water at an interface of a reverse osmosis membrane of the reverse osmosis element.

Another object of the present invention is to provide a reverse osmosis spacer with a high recovery rate, which is capable of decreasing less a salt removal rate by increasing a flow rate of produced water when a reverse osmosis element operates at a high recovery rate of 60% or higher.

### Technical Solution

A reverse osmosis spacer with a high recovery rate according to the present invention can have a mesh shape having a plurality of strands having predetermined intersection points and can operate at a recovery rate of 60 to 80%.

In addition, a thickness of the reverse osmosis spacer with a high recovery rate can be 8 to 25 mil.

In addition, an angle at one side between the intersection points between the strands can be 70° to 90°.

In addition, SPI (stand per Inch) of the strands can be 15 to 35.

In addition, the strands can form a mesh having a two-layer structure.

A reverse osmosis element with a high recovery rate according to the present invention can include the reverse osmosis spacer with a high recovery rate according to the present invention.

In addition, the reverse osmosis element can include: a tube including an opening configured to receive a permeable liquid in a longitudinal direction; one or more reverse osmosis membranes wound around the tube and extending outward from the tube; and the reverse osmosis spacer wound around the tube and being in contact with the one or more reverse osmosis membranes.

In addition, the reverse osmosis element with a high recovery rate can operate at pressure of 60 psi.

In addition, the reverse osmosis element can operate at raw water concentration of 20 ppm.

In addition, the reverse osmosis spacer with a high recovery rate can be stacked multiple times.

### Advantageous Effects

According to the present invention, it is possible to provide the reverse osmosis element with a high recovery rate, which is capable of reducing ion polarization in the reverse osmosis element by creating an effective flow of raw water at the interface of the reverse osmosis membrane of the reverse osmosis element.

In addition, according to the present invention, it is possible to provide the reverse osmosis spacer with a high recovery rate, which is capable of decreasing less a salt removal rate by increasing a flow rate of produced water when the reverse osmosis element operates at a high recovery rate of 60% or higher.

### BRIEF DESCRIPTION OF DRAWINGS

FIG. 1 is a perspective view of a reverse osmosis element 100 with a high recovery rate according to an exemplary embodiment of the present invention.

### DETAILED DESCRIPTION

Hereinafter, the present invention will be described in detail with reference to the accompanying drawings. Here, repeated descriptions and detailed descriptions of publicly-known functions and configurations, which may unnecessarily obscure the subject matter of the present invention, will be omitted. Exemplary embodiments of the present invention are provided to completely explain the present invention to a person with ordinary skill in the art. Therefore, shapes and sizes of elements illustrated in the drawings may be exaggerated for a more apparent description.

Throughout the specification, unless explicitly described to the contrary, the word “comprise” or “include” and variations, such as “comprises”, “comprising”, “includes” or “including”, will be understood to imply the inclusion of stated constituent elements, not the exclusion of any other constituent elements.

Hereinafter, exemplary embodiments are proposed to help understand the present invention. However, the following exemplary embodiments are provided just for more easily understanding the present invention, and the contents of the present invention are not limited by the exemplary embodiments.

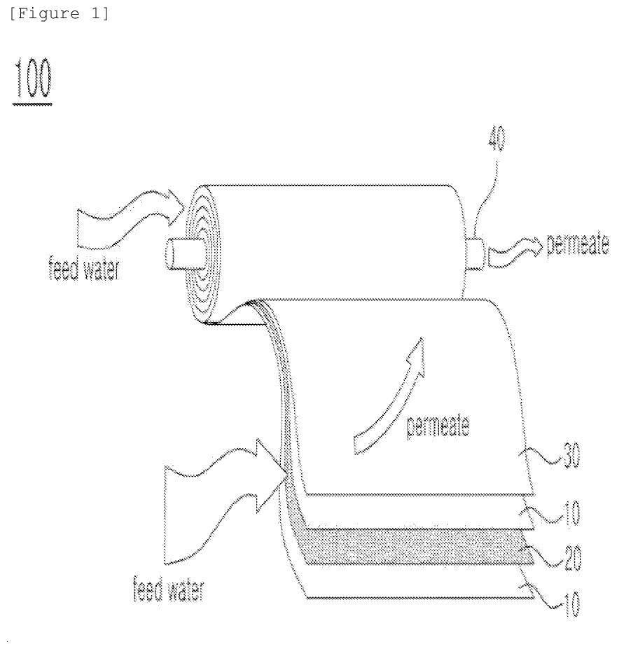

FIG. 1 is a perspective view of a reverse osmosis element 100 with a high recovery rate according to an exemplary embodiment of the present invention.

The reverse osmosis element 100 with a high recovery rate can include reverse osmosis membranes 10, a reverse osmosis spacer 20 with a high recovery rate, a tricot filtered water channel 30, and a tube 40.

The reverse osmosis element 100 with a high recovery rate can be configured such that the reverse osmosis membranes 10, the reverse osmosis spacer 20 with a high recovery rate, and the tricot filtered water channel 30 are stacked multiple times and surround the tube 40. The reverse osmosis spacer 20 with a high recovery rate is positioned between the reverse osmosis membranes 10 and maintains a constant interval between the reverse osmosis membranes 10. The reverse osmosis spacer 20 can serve to block a surface of the reverse osmosis membrane 10 in order to filter out contaminants contained in raw water introduced through the reverse osmosis membrane 10. Therefore, in order to enable contaminants contained in the raw water to flow without being collected, the reverse osmosis spacer 20 with a high recovery rate can have a mesh shape made by a plurality of strands arranged to have predetermined intersection points. In this case, a material of the strand can be, but not particularly limited to, any one of polyethylene (PE), polyvinyl chloride (PVC), polyester, and polypropylene (PP). The mesh shape can have a two-layer structure.

First, some strands are disposed in parallel at predetermined intervals in a direction inclined with respect to a flow direction of raw water. Thereafter, the remaining strands are disposed in parallel at predetermined intervals on the previous strands in a reversely inclined direction symmetrical to the inclined direction in order to form the intersection points. The mesh shape can be a parallelogrammatic shape having identical sides based on positions of the disposed strands. In this case, an angle at one side of the parallelogram with respect to the flow direction of the raw water is 70° to 90°. If the angle of the parallelogram exceeds 90°, flow resistance of the raw water increases, which can cause an increase in differential pressure. In contrast, if the angle of the parallelogram is less than 70°, the interruption of the strands is decreased, such that residual substances, which are produced when the raw water is filtered and produced water is produced, remain at the interface of the reverse osmosis membrane, and as a result, concentration of the raw water at the interface of the reverse osmosis membrane is increased, which can cause a decrease in salt removal rate.

Meanwhile, since the reverse osmosis spacer 20 with a high recovery rate has the mesh shape having the parallelogrammatic shape with the identical sides, all of the strands have the same SPI (strand per Inch). The SPI refers to the number of intersection points between the strands included in a length of 1 inch. The SPI of the strands can be 15 to 35. If the SPI is smaller than 15, the ion polarization occurs, such that the raw water may not be mixed, the salt removal rate may be decreased, and a performance of the reverse osmosis element 100 may deteriorate. In contrast, if the SPI is larger than 35, there is an effect of inhibiting the ion polarization, but there may be a problem in that a pressure loss is increased in the reverse osmosis spacer 20 with a high recovery rate.

In addition, a thickness of the reverse osmosis spacer with a high recovery rate can be 8 to 25 mil. If the thickness is smaller than 8 mil, the flow path can be clogged with foreign substances contained in the raw water or power required for a pump for pumping the raw water can be increased. If the thickness is larger than 25 mil, the flow path is widened such that the differential pressure can be reduced, but the effect of reducing the ion polarization can deteriorate during the operation under a condition at a high recovery rate.

When the reverse osmosis spacer 20 with a high recovery rate satisfies one or more of the thickness of the strand, the angle at one side between the intersection points, and the SPI, the effect of mixing the flows of the raw water is improved, such that the ion polarization can be mitigated.

The tricot filtered water channel 30 according to the present invention generally has a woven fabric structure and serves as a flow path having a space through which water purified by the reverse osmosis membrane 10 flows out.

The tube 40 according to the present invention is positioned at a center of the reverse osmosis element 100 with a high recovery rate and serves as a passageway through which the filtered water is introduced and discharged. To this end, voids (or openings) having predetermined sizes can be formed in an outer portion of the tube 40 so that the filtered water is introduced through the voids. In this case, the one or more voids can be formed so that the filtered water can be introduced more efficiently.

The reverse osmosis element 100 with a high recovery rate can satisfy all of the thickness of the strand of the reverse osmosis spacer 20 with a high recovery rate, the angle of one side between the intersection points, and the SPI and can operate at raw water concentration of 20 ppm, operating pressure of 60 psi, and a recovery rate of 60 to 80%. In this case, the reverse osmosis elements, which satisfy the recovery rate of 60 to 80%, can operate by continuously connecting the plurality of reverse osmosis elements with a recovery rate of 15% in accordance with a condition of the recovery rate. If the reverse osmosis element operates at a recovery rate less than 60%, a flow rate of produced water is low. If the reverse osmosis element operates at a recovery rate exceeding 80%, the amount of filtered water is increased, and the ion polarization becomes severe at the interface of the reverse osmosis membrane, such that a rate of removing salt contained in the raw water can be greatly decreased. Therefore, when the reverse osmosis element 100 with a high recovery rate operates at the high recovery rate of 60 to 80%, a flow rate of produced water can be effectively increased, a salt removal rate can be less decreased, and the amount of discarded water can be reduced.

### Comparative Example 1

A reverse osmosis spacer in the related art was prepared in which a thickness of the reverse osmosis spacer with a high recovery rate is 22 mil, an angle at one side between intersection points is 90°, and SPI is 16.

### Comparative Example 2

A reverse osmosis spacer in the related art was prepared in which a thickness of the reverse osmosis spacer with a high recovery rate is 17 mil, an angle at one side between intersection points is 90°, and SPI is 16.

### Example 1

A reverse osmosis spacer with a high recovery rate according to the present invention was prepared in which a thickness of the reverse osmosis spacer with a high recovery rate is 8 mil, an angle at one side between intersection points is 90°, and SPI is 16.

### Example 2

A reverse osmosis spacer with a high recovery rate according to the present invention was prepared in which a thickness of the reverse osmosis spacer with a high recovery rate is 13 mil, an angle at one side between intersection points is 80°, and SPI is 33.

TABLE 1

| | Thickness (mil) | Angle (°) | SPI |
|---|---|---|---|
| Comparative | 22 | 90 | 16 |
| Example 1 | | | |
| Comparative | 17 | 90 | 16 |
| Example 2 | | | |
| Example 1 | 8 | 90 | 16 |
| Example 2 | 13 | 80 | 33 |

TABLE 2

| | | | High Recovery Rate | |
|---|---|---|---|---|
| | Recovery Rate (15%) | | (60%) | |
| | | Flow | | Flow |
| | Salt Removal | Rate | Salt Removal | Rate |
| | Rate (%) | (GFD) | Rate (%) | (GFD) |
| Comparative | 98.6 | 21.1 | 93 | 26.9 |
| Example 1 | | | | |
| Comparative | 98.5 | 23 | 94 | 30.4 |
| Example 2 | | | | |
| Example 1 | 98.7 | 27.8 | 94.9 | 37.1 |
| Example 2 | 98.7 | 23.6 | 94.6 | 33.5 |

These values are obtained by measuring the salt removal rate and the flow rate in the reverse osmosis element at the raw water concentration of 20 ppm and the operating pressure of 60 psi. The reverse osmosis spacers according to the examples and the comparative examples each are formed in a mesh shape. Referring to Tables 1 and 2, Comparative Examples 1 and 2 used the reverse osmosis spacers in the related art, and Examples 1 and 2 used the reverse osmosis spacers with a high recovery rate according to the present invention. First, when comparing Comparative Examples 1 and 2 and Example 1, the angles at one side between the intersection points between the strands were equally 90°, the SPIs were equally 16, and the thickness of the reverse osmosis spacer with a high recovery rate was 22 mil in Comparative Example 1, 17 mil in Comparative Example 2, and 8 mil in Example 1. First, as a result of measuring the salt removal rate at the recovery rate of 15%, the salt removal rate was 98.6% in Comparative Example 1, 98.5% in Comparative Example 2, and 98.7% in Example 1. In addition, as a result of measuring the flow rate at the recovery rate of 15%, the flow rate was 21.1 GFD in Comparative Example 1, 23 GFD in Comparative Example 2, and 27.8 GFD in Example 1. As a result of measuring the salt removal rate at the high recovery rate of 60%, the salt removal rate was 93% in Comparative Example 1, 94% in Comparative Example 2, and 94.9% in Example 1. In addition, as a result of measuring the flow rate at the high recovery rate of 60%, the flow rate was 26.9 GFD in Comparative Example 1, 30.4 GFD in Comparative Example 2, and 37.1 GFD in Example 1. In Comparative Example 1, the salt removal rate was decreased by 5.6% and the flow rate was increased by 5.8 GFD under the condition of the recovery rate of 60% in comparison with the condition of the recovery rate of 15%. In Comparative Example 2, the salt removal rate was decreased by 4.5% and the flow rate was increased by 7.4 GFD under the condition of the recovery rate of 60% in comparison with the condition of the recovery rate of 15%. In Example 1, the salt removal rate was decreased by 3.8% and the flow rate was increased by 9.3 GFD under the condition of the recovery rate of 60% in comparison with the condition of the recovery rate of 15%. Therefore, it can be ascertained that as the thickness (mil) of the reverse osmosis spacer with a high recovery rate becomes smaller, the flow rate of the produced water in the reverse osmosis element can be further increased and the salt removal rate can be less decreased, compared to the related art, when the reverse osmosis element operates at the high recovery rate.

In the case of Example 2, the thickness of the reverse osmosis spacer with a high recovery rate was 13 mil, the angle at one side between the intersection points was 80°, and the SPI was 33. First, as a result of measuring the salt removal rate at the recovery rate of 15%, the salt removal rate was 98.7%, and the flow rate was 23.6 GFD. In contrast, as a result of measuring the salt removal rate at the high recovery rate of 60%, the salt removal rate was 94.6%, and the flow rate was 33.5 GFD. Therefore, in Example 2, the salt removal rate was decreased by 4.1% and the flow rate was increased by 9.9 GFD under the condition of the recovery rate of 60% in comparison with the condition of the recovery rate of 15%. Therefore, it can be ascertained that when the angle at one side between the intersection points between the strands is decreased and the SPI of the strands is increased even though the thickness of the strand is increased, the flow rate of the produced water in the reverse osmosis element can be increased, and the salt removal rate can be less decreased, compared to the related art, like Example 1.

That is, it can be ascertained that with the use of the reverse osmosis spacer with a high recovery rate according to the present invention which satisfies the condition in which the thickness of the strand is 8 to 25 mil, the angle between the intersection points is 70° to 90°, and the SPI is 15 to 35 and the use of the reverse osmosis element with a high recovery rate which satisfies the condition in which the raw water concentration is 20 ppm, the operating pressure is 60 psi, and the recovery rate is 60%, the flow rate of the produced water is maximized, and the salt removal rate is decreased less compared to the related art.

While the present invention has been described above with reference to the exemplary embodiments, it can be understood by those skilled in the art that the present invention can be variously modified and changed without departing from the spirit and scope of the present invention disclosed in the claims.

1. A reverse osmosis spacer with a high recovery rate, wherein the reverse osmosis spacer has a mesh shape having a plurality of strands having predetermined intersection points and operates at a recovery rate of 60 to 80%, wherein an angle at one side between the intersection points between the strands is 70° to 90°.

2. The reverse osmosis spacer of claim 1, wherein a thickness of the reverse osmosis spacer with a high recovery rate is 8 to 25 mil.

3. (canceled)

4. The reverse osmosis spacer of claim 1, wherein an SPI (stand per Inch) of the strands is 15 to 35.

5. The reverse osmosis spacer of claim 1, wherein the strands form a mesh having a two-layer structure, wherein a first set of strands are arranged in a first layer, and a second set of strands are disposed on the first set of strands forming a second layer.

6. A reverse osmosis element with a high recovery rate, the reverse osmosis element comprising the reverse osmosis spacer with a high recovery rate according to claim 1.

7. The reverse osmosis element of claim 6, comprising:
a tube comprising an opening configured to receive a permeable liquid in a longitudinal direction;
one or more reverse osmosis membranes wound around the tube and extending outward from the tube; and
the reverse osmosis spacer wound around the tube and being in contact with the one or more reverse osmosis membranes.

8. The reverse osmosis element of claim 7, wherein the reverse osmosis element operates at pressure of 60 psi.

9. The reverse osmosis element of claim 7, wherein the reverse osmosis element operates at a raw water concentration of 20 ppm.

10. The reverse osmosis element of claim 7, wherein the reverse osmosis spacer with a high recovery rate is stacked multiple times around the tube.
